(19) United States
(12) Patent Application Publication
(10) Pub. No.: US 2024/0367130 A1
(43) Pub. Date: Nov. 7, 2024

(54) SLURRY PHOTOREACTOR DRIVEN BY HYBRID AND ARTIFICIAL LIGHT SOURCES

(71) Applicant: Qatar Foundation for Education, Science and Community Development, Doha (QA)

(72) Inventors: Konstantinos E. Kakosimos, Doha (QA); Mohammed Al Hashimi, Doha (QA); Suhde Mecid Makki, Doha (QA); Amer Haki, Doha (QA); Ahmed Abbas, Doha (QA); Dhabia Al Mohannadi, Doha (QA); Lina Rueda, Doha (QA); Santhosh Sukumaran, Doha (QA)

(21) Appl. No.: 18/651,140

(22) Filed: Apr. 30, 2024

Related U.S. Application Data
(60) Provisional application No. 63/463,446, filed on May 2, 2023.

(51) Int. Cl. B01J 8/08

(52) U.S. Cl. CPC B01J 8/085; B01J 2208/00787

(57) ABSTRACT

A hybrid slurry reactor for performing photocatalytic reactions is provided. The hybrid slurry reactor includes a photoreactor, including a conduit, having a transparent portion, a light-emitting diode (LED) array disposed within the conduit; wherein the conduit is configured such that photons from an external source enter the conduit through the transparent portion and the LED array is directed to emit photons into the conduit.

### CROSS-REFERENCES

This application claims priority to U.S. Provisional Application No. 63/463,446, filed on May 2, 2023, the entirety of which is incorporated herein by reference.

### BACKGROUND

With an increasing need for alternative energy sources, solar energy is expected to become a major energy contributor in the future. This increase in demand is also encouraged by the growing markets of hydrogen production, synthesis of platform chemicals (e.g., methanol, acetylene), methane reforming, and carbon dioxide reuse at a centralized or distributed scheme. However, current solar technology includes various disadvantages. For example, many solar energy systems are reliant on sunlight, which has key weakness due to the intermittent character that occurs because of diurnal and regional radiation variations. Weather events also affect systems reliant on solar energy. Existing technologies either ignore this weakness by proposing sunlight driven photocatalytic processes or completely surpass solar systems by proposing a system that fully relies on artificial light. Systems that rely on artificial light, for example, light emitting diodes (“LEDs”), also have significant weaknesses. Namely, artificial light consumes a significant amount of electrical power.

### SUMMARY

Without limiting the present disclosure in any way, in a first aspect of the present disclosure, which may be combined with any other aspect listed herein unless specified otherwise, a hybrid slurry reactor for performing photocatalytic reactions is provided. The hybrid slurry reactor includes a photoreactor, including a conduit, having a transparent portion, a light-emitting diode (LED) array disposed within the conduit; wherein the conduit is configured such that photons from an external source enter the conduit through the transparent portion and the LED array is directed to emit photons into the conduit.

In a variation of this embodiment, the LED array is controlled such that a first sum of photons received over a first period of time of a predefined duration from the external source and the LED array is substantially equal to a second sum of photons received over a second period of time of the predefined duration from the external source and the LED array, wherein a different quantity of photons are received from the external source during the first period of time and the second period of time.

In another variation of this embodiment, the conduit is configured to carry a photoreactive slurry that produces a chemical product when the photoreactive slurry interfaces with at least one of the photons from the external source and photons emitted by the LED array.

In another variation of this embodiment, the conduit includes an inlet configured to facilitate an input of a photoreactive slurry containing chemical reactants to the conduit, and an outlet configured to facilitate removal of the photoreactive slurry containing chemical products from the conduit.

In another variation of this embodiment, the photoreactor is configured such that such that a photoreactive slurry convectively removes excess heat produced by the LED array, decreasing, or maintaining a temperature of the LED array and increasing a thermal input to the photoreactive slurry.

In another variation of this embodiment, the LED array includes a wiring conduit disposed within the conduit separate from a flow path for a photoreactive slurry through the conduit, such that light-emitting portions of LEDs are disposed on a surface of the wiring conduit contacting the photoreactive slurry, and wires and electrical contacts of the LEDs are physically isolated from the photoreactive slurry within the wiring conduit.

In another variation of this embodiment, the LED array is integrated into a surface of the conduit, such that light emitting portions of LEDs a disposed on an internal surface of a flow path for a photoreactive slurry through the conduit to contact the photoreactive slurry, and wires and electrical contacts of the LEDs are physically isolated from the photoreactive slurry on an external surface of the conduit.

In another variation of this embodiment, the photoreactor includes a group of multiple conduits, each conduit containing an LED array, such that each conduit in the group of conduits is has an inlet configured to receive a photoreactive slurry from one of an external slurry source or an upstream conduit in the group of conduits, and each conduit in the group of conduits has an outlet configured to output the photoreactive slurry to one of an external reservoir or a downstream conduit in the group of conduits.

In another variation of this embodiment, the conduits in the group of conduits are arranged in a parallel array, and the outlet of a given conduit is fluidly connected to the inlet of another conduit by a U-shaped connector.

In a variation of this embodiment, the photons from the external source are directed into the conduit by an articulatable reflective structure, configured to focus rays of the Sun.

In another embodiment, a solar energy system is provided. The solar energy system may include an articulatable reflective structure, configured to focus rays of the Sun, a photoreactor, including: a conduit, having a transparent portion and configured to house a photoreactive slurry′ and a light-emitting diode (LED) array disposed within the conduit, wherein the reflective structure is configured to focus the rays into the transparent portion of the conduit, such that photons from the rays interface with the photoreactive slurry′ the LED array is directed to emit photons into the conduit′ and the conduit is configured such that photons from an external source enter the conduit through the transparent portion.

In a variation of this embodiment, the photoreactor includes a group of multiple conduits, each conduit containing an LED array, wherein each conduit in the group of conduits is has an inlet configured to receive a photoreactive slurry from one of an external source and an upstream conduit in the group of conduits, and each conduit in the group of conduits has an outlet configured to output the photoreactive slurry to one of an external reservoir and a downstream conduit in the group of conduits.

In a variation of this embodiment, the conduits in the group of conduits are arranged in a parallel array, and the outlet of a given conduit is fluidly connected to the inlet of another conduit by a U-shaped connector.

In a variation of this embodiment, the photoreactor includes multiple groups of multiple conduits, the groups arranged in an array.

In a variation of this embodiment, the system further includes a plurality of articulatable reflective structures configured to focus light from the external source into the conduit.

In a variation of this embodiment, the system further includes a control system, the control system configured to manipulate a position of the articulatable reflective structure, thus changing a direction or point of focus of the rays, change a photon output of at least one LED in the LED array, change an input rate and an output rate of a photoreactive slurry to and from the photoreactor.

In another embodiment, a method for facilitating photochemical reactions is provided, including providing a photoreactor including a plurality of conduits having a transparent portion, a light-emitting diode (LED) array disposed within each conduit; communicating, fluidly, a photoreactive slurry, through a flow path defined in each conduit and in contact with the LED array; focusing photons from a light source external to the photoreactor onto the photoreactor, such that the photons from the light source external to the photoreactor interface with the photoreactive slurry; and engaging the LED array such that photons from the LED array interface with the photoreactive slurry; and communicating, fluidly, the photoreactive slurry containing reaction products out of the conduit.

Additional features and advantages of the disclosed method and apparatus are described in, and will be apparent from, the following Detailed Description and the Figures. The features and advantages described herein are not all-inclusive and many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE FIGURES

FIG. 1 illustrates a solar energy system having a hybrid slurry photoreactor, according to embodiments of the present disclosure.

FIGS. 2A-2E illustrate example configurations of hybrid slurry photoreactors, according to various examples of the present disclosure.

FIGS. 3A-3B illustrate views of a first configuration of a conduit of a hybrid slurry photoreactor, according to various examples of the present disclosure.

FIGS. 4A-4B illustrate views of a second configuration of a conduit of a hybrid slurry photoreactor, according to various examples of the present disclosure.

FIGS. 5A-5B illustrate views of a third configuration of a conduit of a hybrid slurry photoreactor, according to various examples of the present disclosure.

FIGS. 6A-6C illustrate views of a fourth configuration of a conduit of a hybrid slurry photoreactor, according to various examples of the present disclosure.

FIG. 7 is a flowchart of an example method for facilitating a photochemical reaction, according to embodiments of the present disclosure.

### DETAILED DESCRIPTION

The system described herein generally relates to a hybrid slurry reactor for performing photocatalytic reactions. In an example, the photoreactor has a transparent body allowing concentrated solar light to activate and heat the photocatalytic system. This concentrated sunlight may result in higher reaction rates compared to flat systems by providing larger amounts of electromagnetic energy in the Ultraviolet-Visible wavelengths and by increasing the reacting system's temperature. In some examples, the system also uses an artificial light of an array of LEDs. The array of LEDs, with the appropriate position and wavelength distribution, counteract solar radiation shifts throughout the day, yielding a hybrid system capable of driving photocatalytic and heterogeneous reactions (e.g., hydrogen production via water splitting) continuously and without interruption.

Additionally, the system may couple the artificial light sources' waste heat management with the photocatalytic system's ability to handle elevated temperatures. In an example, the system couples the heat management with the photocatalytic system by fully or partly immersing the array of LEDs in the slurry suspension, which acts as a cooling fluid for the LEDs. In turn, the heat provided by the LEDs increases the temperature of the slurry and photocatalyst, thereby yielding higher reaction rates.

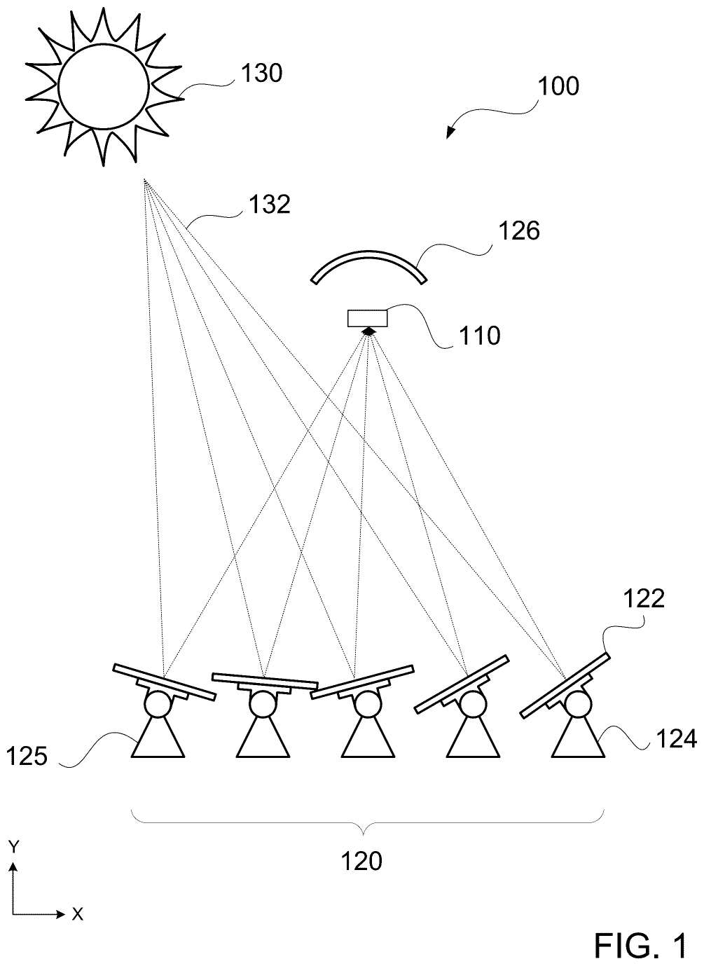

FIG. 1 illustrates a solar energy system 100 having a hybrid slurry photoreactor 110, according to various examples of the present disclosure. FIG. 1 illustrates a linear Fresnel system 120, including a series of articulatable reflective structures 125, each having a rotatable base 124 and a flat mirror 122. The reflective structures 125 are configured to reflect rays 132 from the sun 130 and focus the rays 132 on the photoreactor 110, thus concentrating the rays 132, facilitating a photo-chemical reaction in the photoreactor 110.

When used in tandem, a plurality of reflective structures 125 may redirect the rays 132, which are naturally incident over a large surface area, to a comparably smaller area, or focus, thus increasing the photon density at the focus. When the focus is manipulated such that the focus is incident with the photoreactor 110, a much larger quantity of photons may be directed into the photoreactor 110, compared to the quantity of photons in otherwise naturally incident rays 132.

The Fresnel system 120 may further include a secondary concentrator 126, disposed opposite to the reflective structures 125 (relative to the photoreactor 110) to re-reflect rays 132 that are not incident with the photoreactor 110 after being reflected by the reflective structures 125.

The solar energy system 100 may include various conventional structures which are not illustrated in FIG. 1, such as structural members to elevate and position the photoreactor 110 and the secondary concentrator 126, various wiring implements to communicate electricity to and from the photoreactor 110 and the reflective structures 125, and conventional plumbing implements to communicate slurry, reactants, and products to and from the photoreactor 110.

The articulatable reflective structures 125 are configured to be manipulated over the course of a solar cycle to redirect rays 132 continuously such that the rays 132 are compatibly incident with the photoreactor 110 regardless of the position of the sun 130. In some embodiments, the articulatable reflective structures 125 may be manipulated via motors in communication with a control system.

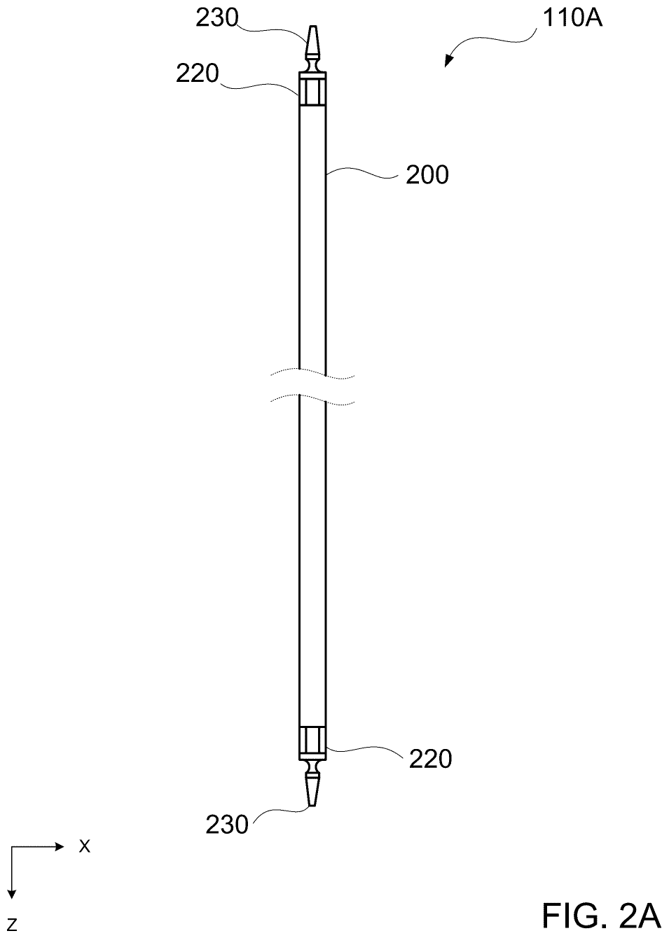

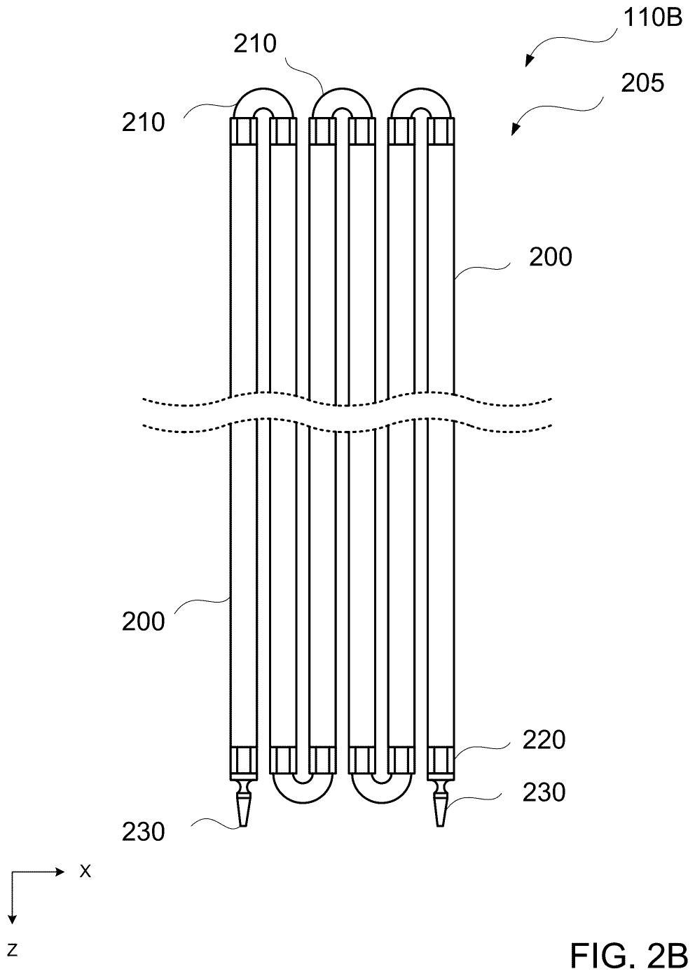

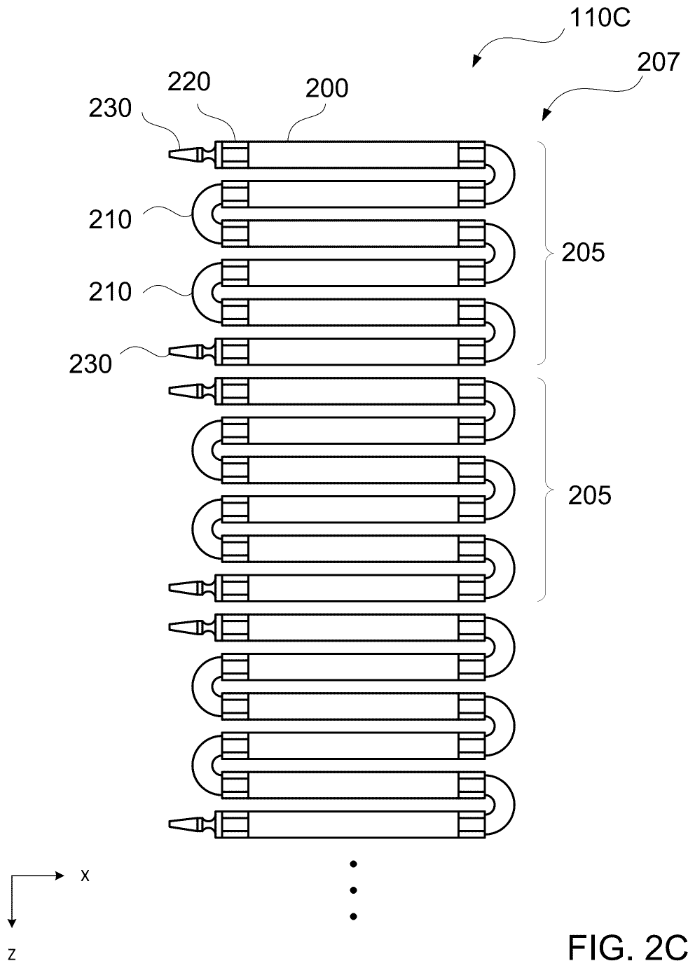

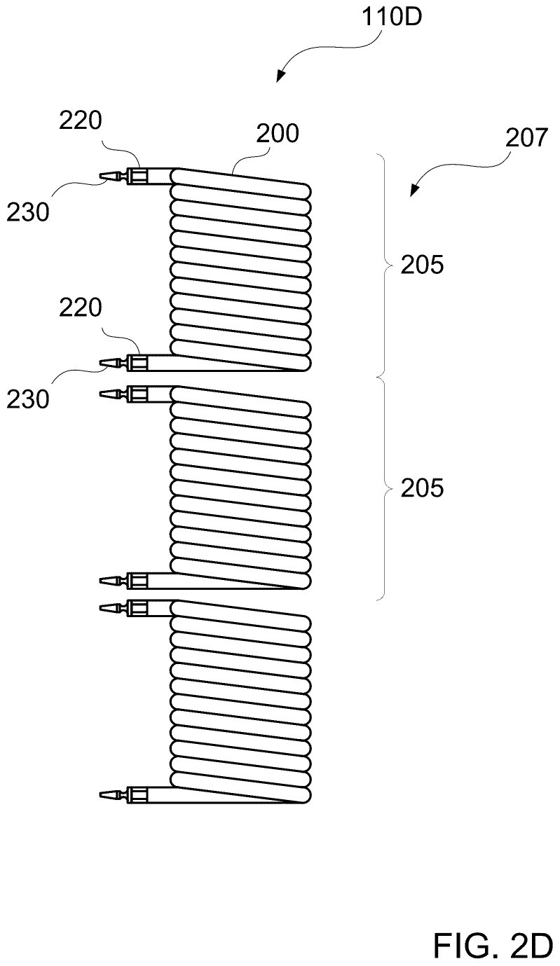

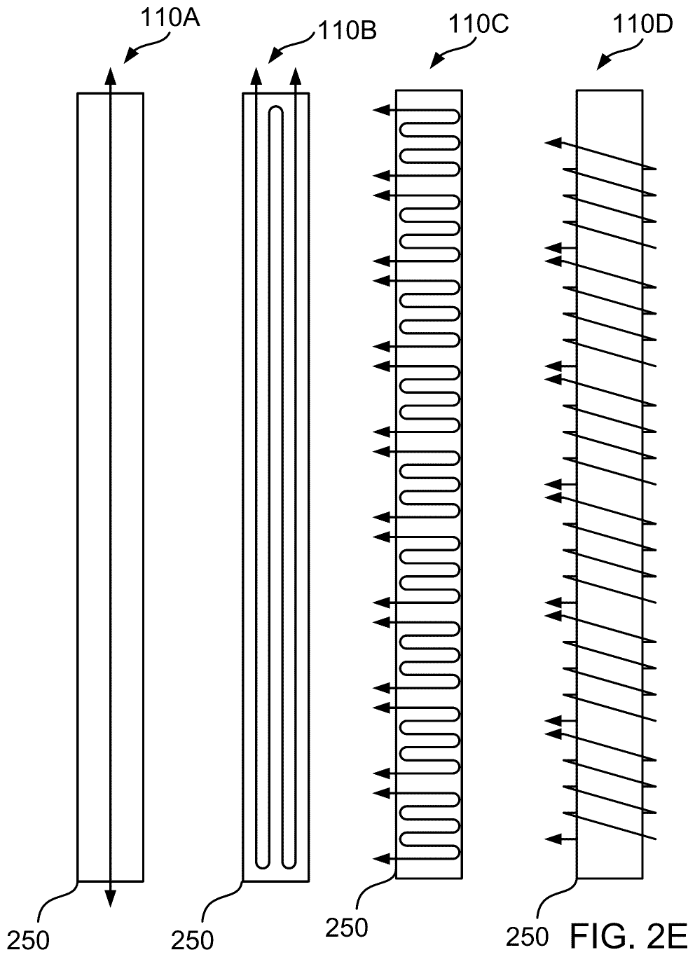

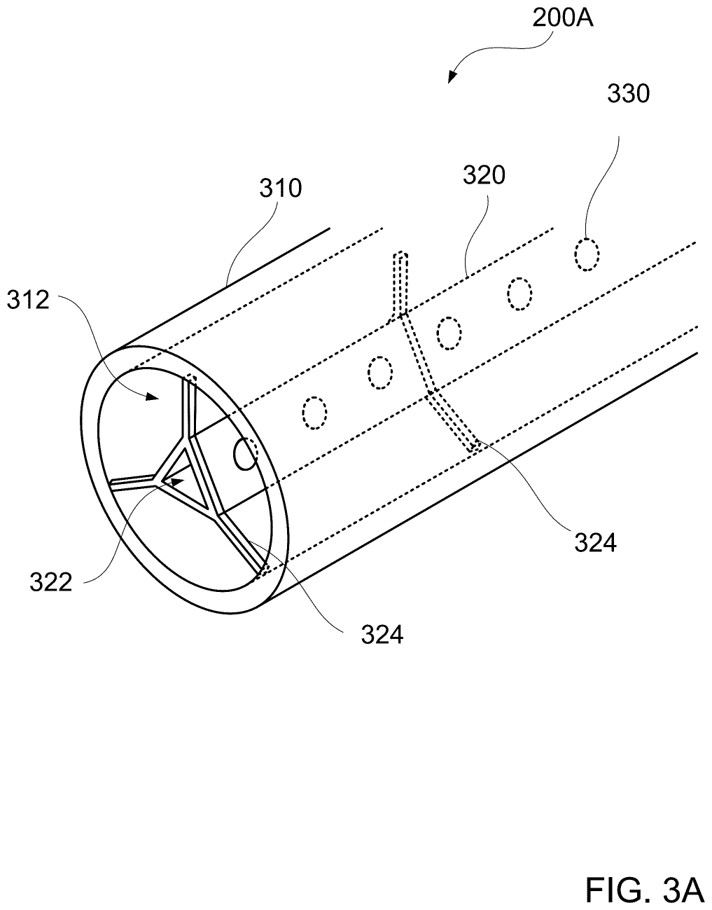

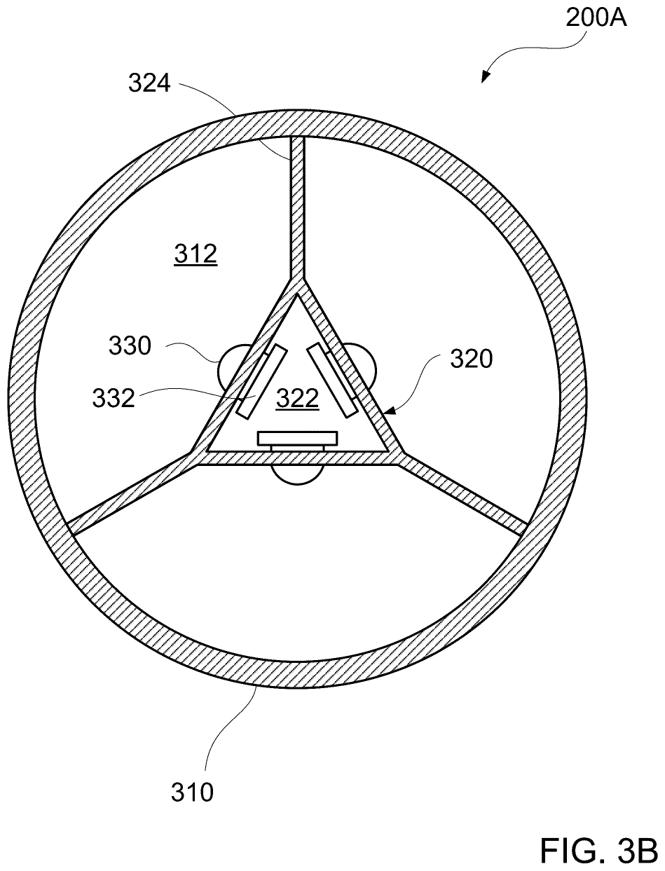

FIG. 2A illustrates a first configuration 110A of a hybrid slurry photoreactor 110, including a conduit 200, sealing nuts 220, and hose connectors 230, according to embodiments of the present disclosure. The conduit 200 and the various embodiments thereof are discussed in greater detail in the description of FIGS. 3A-5B. The first configuration 110A shown in FIG. 2A is a linear configuration, having a single conduit 200, with two hose connectors 230 on either end, one hose connector 230 configured to provide an inlet to the conduit 200, the other hose connector 230 is configured to provide an outlet from the conduit 200, the inlet and outlet configured to commute slurry to and from the conduit 200. The hose connectors 230 may be joined to the conduit 200 by sealing nuts 220.

In some embodiments, the first configuration 200A may define a flow path of photoreactive slurry through the photoreactor 110 originating at an inlet hose connector 230 and terminating at an outlet hose connector 230. With regard to the flowpath, a point on, or feature of, the photoreactor more proximate to the inlet hose connector 230 than a reference point may be considered “upstream” of the reference point. Conversely, a point on, or feature of, the photoreactor more proximate to the outlet hose connector 230 than a reference point may be considered “downstream” of the reference point.

According to some embodiments, a hybrid slurry photoreactor 110 may include one or more hybrid slurry photoreactors 110 arrayed or arranged proximately to one another in a single solar energy system 100.

FIG. 2B illustrates a second configuration 110B of a hybrid slurry photoreactor 110, including several conduits 200, U-bend connectors 210, sealing nuts 220 and hose connectors 230, according to embodiments of the present disclosure. The second configuration 110B as shown in FIG. 2B is a reciprocal pattern, implementing U-bend connectors to join several parallel sections of conduit 200. As illustrated in the second configuration 110B, a first hose connector 230 provides an inlet to a first section of conduit 200, which is joined via a first U-bend connector 210 to a second section of conduit 200, parallel to the first section of conduit 200, and the second section of conduit 200 is joined to a third parallel section of conduit 200 via a second U-bend connector 210. This pattern propagates in a serpentine manner through several parallel sections of conduit 200 to form a reactor unit 205, culminating with a hose connector 230 forming an outlet, parallel to the inlet hose connector 230.

In some embodiments, the second configuration 200B may define a flow path of photoreactive slurry through the photoreactor 110 originating at an inlet hose connector 230 and terminating at an outlet hose connector 230. With regard to the flowpath, a point on, or feature of, the photoreactor more proximate to the inlet hose connector 230 than a reference point may be considered “upstream” of the reference point. Conversely, a point on, or feature of, the photoreactor more proximate to the outlet hose connector 230 than a reference point may be considered “downstream” of the reference point.

Although illustrated as having six sections of conduit 200 per reactor unit 205, the present disclosure contemplates embodiments in which a given reactor unit 205 has any number of sections of connected conduit 200. The length of the conduits 200 may vary between embodiments and correspond to the desired properties of the solar energy system 100 in which the conduits 200 are implemented. In some examples, a conduit 200 may have a length between 0.1 and 5 meters (as measured in the Z direction in FIG. 2B).

FIG. 2C illustrates a third configuration 110C of the hybrid slurry photoreactor 110, which is a variation of the second configuration 110B, and may be configured to have several reactor units 205 arranged into an array 207 of reactor units 205. As illustrated in FIG. 2C, the array 207 is a linear array, however the present disclosure contemplates embodiments wherein reactor units 205 are incorporated into multi-dimensional arrays. In some embodiments, the array 207 of the third configuration 110C may include any number of reactor units 205. The third configuration 110C may employ shorter lengths of conduit 200 and greater quantities of conduits 200 per reactor unit 205 relative to the lengths of conduits 200 and the quantities of conduits 200 employed in the second configuration 110B.

In some embodiments, the third configuration 110C may define a flow path of photoreactive slurry through the photoreactor 110 originating at an inlet hose connector 230 and terminating at an outlet hose connector 230. With regard to the flowpath, a point on, or feature of, the photoreactor more proximate to the inlet hose connector 230 than a reference point may be considered “upstream” of the reference point. Conversely, a point on, or feature of, the photoreactor more proximate to the outlet hose connector 230 than a reference point may be considered “downstream” of the reference point.

FIG. 2D illustrates a fourth configuration 110D of the hybrid slurry photoreactor 110, which is a helical variation of the second embodiment 110B, according to various examples of the present disclosure. The fourth embodiment 110D includes multiple helical reactor units 205 arranged into an array 207, however in some examples the fourth configuration 110D may only include a single helical reactor unit 205.

In some embodiments, the fourth configuration 200D may define a flowpath of photoreactive slurry through the photoreactor 110 originating at an inlet hose connector 230 and terminating at an outlet hose connector 230. With regard to the flowpath, a point on, or feature of, the photoreactor more proximate to the inlet hose connector 230 than a reference point may be considered “upstream” of the reference point. Conversely, a point on, or feature of, the photoreactor more proximate to the outlet hose connector 230 than a reference point may be considered “downstream” of the reference point.

FIG. 2E illustrates schematic diagrams of the first configuration 110A, second configuration 110B, third configuration 110C, and fourth configuration 110D of the hybrid slurry photoreactor 110 as may be implemented in conjunction with a housing or structural apparatus (represented as box 250) in the solar energy system 100.

FIGS. 3A-3B illustrate a first configuration 200A of the conduit 200, according to embodiments of the present disclosure. The first configuration 200A includes a tube 310 defining the slurry channel 312, a wiring conduit 320 (e.g., inner conduit, second conduit) disposed within the slurry channel 312, defining a wiring channel 322, which is physically isolated from the slurry channel 312. The wiring conduit 320 is fixed within the tube 310 via support braces 324. The first configuration 200A further includes light-emitting diodes (LEDs) 330 disposed through an external surface of the wiring conduit 320 and exposed to the slurry channel 312. The LEDs 330 may include wires and dissipation plates 332, which are disposed on the inside of the wiring conduit 320, and physically isolated from the slurry and the slurry channel 312, as liquid slurry could potentially short the circuits of the LEDs or have other damaging effects on the wiring side of the LEDs 330.

According to some embodiments, the tube 310 is transparent, or includes a transparent portion, such that external photons, (e.g., from rays 132) may effectively enter the conduit 200. The tube 310 may also be constructed of a non-reactive transparent material, which may be selected respondent to a desired photochemical reaction to be conducted in the photoreactor 110. According to some embodiments, the tube 310 may be constructed of quartz, glass, acrylic, polyvinyl chloride, nylon, polyurethane, polyethylene, polycarbonate, plexiglass, combinations thereof, and the like.

As illustrated in FIGS. 3A-3B, the internal conduit 320 has a triangular cross section, which facilitates three surfaces for the disposition of LEDs 330. According to some embodiments, the internal conduit 320 may possess a circular cross section, or a polygonal cross section (e.g., square, rectangular, hexagonal, and the like). The wiring conduit 320 may be constructed of a material that is non-reactive with the slurry used for the desired photochemical reaction or include a coating or finish that serves as a barrier between the surface of the wiring conduit 320 and the slurry. According to some embodiments, the wiring conduit 320 may be constructed of a metal (e.g., aluminum, copper, steel, brass, nickel, silver, gold, titanium, palladium, various alloys, and the like), quartz, glass, acrylic, plastic, polyvinyl chloride, nylon, polyurethane, polyethylene, polycarbonate, plexiglass, and combinations thereof. Further, the wiring conduit 320 may include a coating or finish, which may include, silicon-based coatings (silicon dioxide, silicon oxide), metal finishes (via electrolytic deposition or otherwise), ceramic coatings, plastic coatings, combinations thereof and the like.

According to some embodiments, the first configuration 200A may include LEDs 330 disposed on one or more sides of the wiring conduit 320. As illustrated in FIG. 3B, the first configuration includes LEDs 330 disposed on all three sides of the triangular wiring conduit 320. In some examples, the LEDs 330 may be disposed on a single side, only two sides, or in embodiments, with a greater number of sides, four or more sides. Placement of the LEDs 330 may be determined by the unit output of the LEDs 330, the configuration of the solar energy system 100 (e.g., such that light contacts a single side of the conduit 200 vs. multiple sides of the conduit 200, volume of external light input, etc.), or the light requirements of a desired photochemical reaction to be conducted in the photoreactor 110. The placement density of LEDs 330 along a single side may also be determined and implemented responsive to the same parameters.

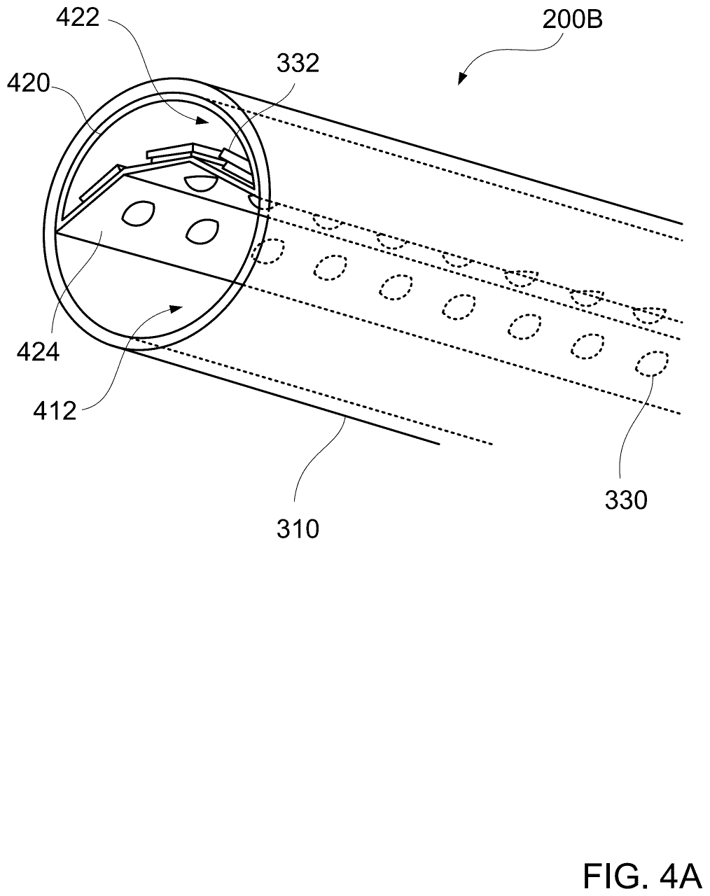

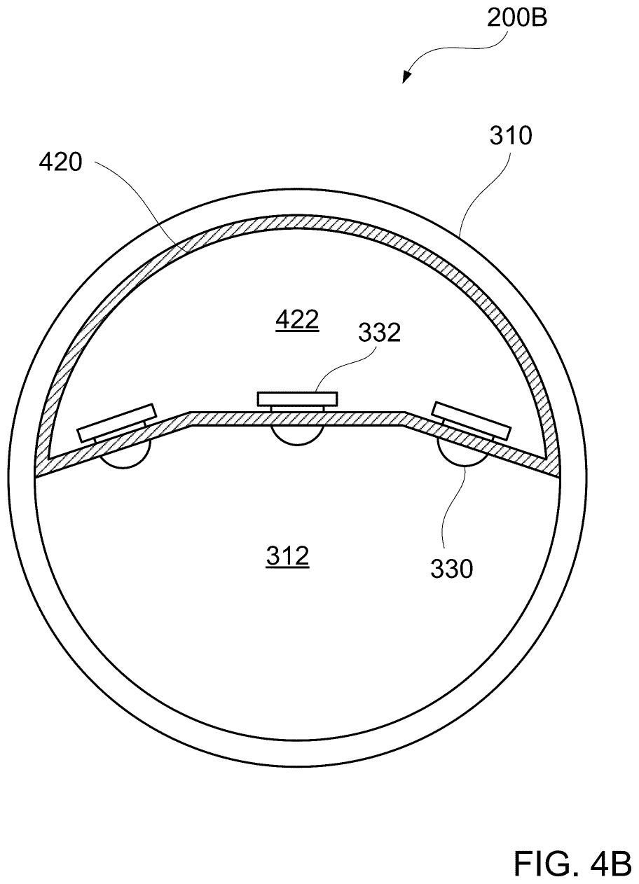

FIGS. 4A-4B illustrate a second configuration 200B of the conduit 200, according to embodiments of the present disclosure. The second configuration 200B includes a tube 310 defining the slurry channel 412, a wiring conduit 420 (e.g., inner conduit, second conduit) disposed within the tube 310, defining a wiring channel 422 which is physically isolated from the slurry channel 412. The wiring conduit 420 includes an external surface matched with an internal surface of the tube 310 and further includes one or more external surfaces 424 exposed to the slurry channel 312, through which the LEDs 330 are disposed.

According to some embodiments, the tube 310 is transparent, or includes a transparent portion, such that external photons, (e.g., rays 132) may effectively enter the conduit 200. The tube 310 may also be constructed of a non-reactive transparent material, which may be selected respondent to a desired photochemical reaction to be conducted in the photoreactor 110. According to some embodiments, the tube 310 may be constructed of quartz, glass, acrylic, polyvinyl chloride, nylon, polyurethane, polyethylene, polycarbonate, plexiglass, combinations thereof, and the like.

The cross-sectional profile of the wiring conduit 420 may be substantially semi-circular, where the diametral surface 424 of the semi-circle may include a convex face, or a polygonal surface with several faces. In the illustrated embodiments of FIGS. 4A-4B, the cross-sectional profile of the wiring conduit 420 includes a concave polygonal surface with three faces.

According to some embodiments, the wiring conduit 420 may be constructed of a material that is non-reactive with the slurry used for the desired photochemical reaction or include a coating or finish that serves as a barrier between the surface of the wiring conduit 420 and the slurry. According to some embodiments, the wiring conduit 420 may be constructed of a metal (e.g., aluminum, copper, steel, brass, nickel, silver, gold, titanium, palladium, various alloys, and the like), quartz, glass, acrylic, plastic, polyvinyl chloride, nylon, polyurethane, polyethylene, polycarbonate, plexiglass, and combinations thereof. Further, the wiring conduit 420 may include a coating or finish, which may include, silicon based coatings (silicon dioxide, silicon oxide), metal finishes (via electrolytic deposition or otherwise), ceramic coatings, plastic coatings, combinations thereof and the like.

According to some embodiments, the second configuration 200B may include LEDs 330 disposed on the diametral surface(s) 424 of the wiring conduit 420. As illustrated in FIG. 4B, the second configuration includes LEDs 330 disposed on all three diametral surfaces 424 of the wiring conduit 420. In some examples, the LEDs 330 may be disposed on a single side, only two sides, or in embodiments, with a greater number of sides, three or more sides. Placement of the LEDs 330 may be determined by the unit output of the LEDs 330, the configuration of the solar energy system 100 (e.g. light contacts a single side of the conduit 200 vs. multiple sides of the conduit 200, volume of external light input, etc.), or the light requirements of a desired photochemical reaction to be conducted in the photoreactor 110. The placement density of LEDs 330 along a single side may also be determined and implemented responsive to the same parameters.

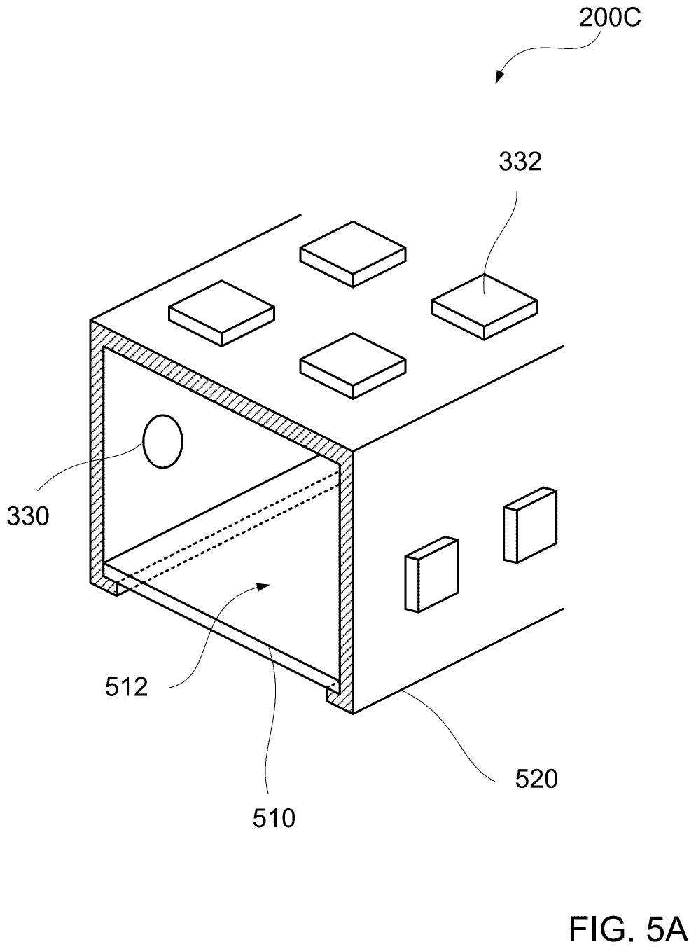

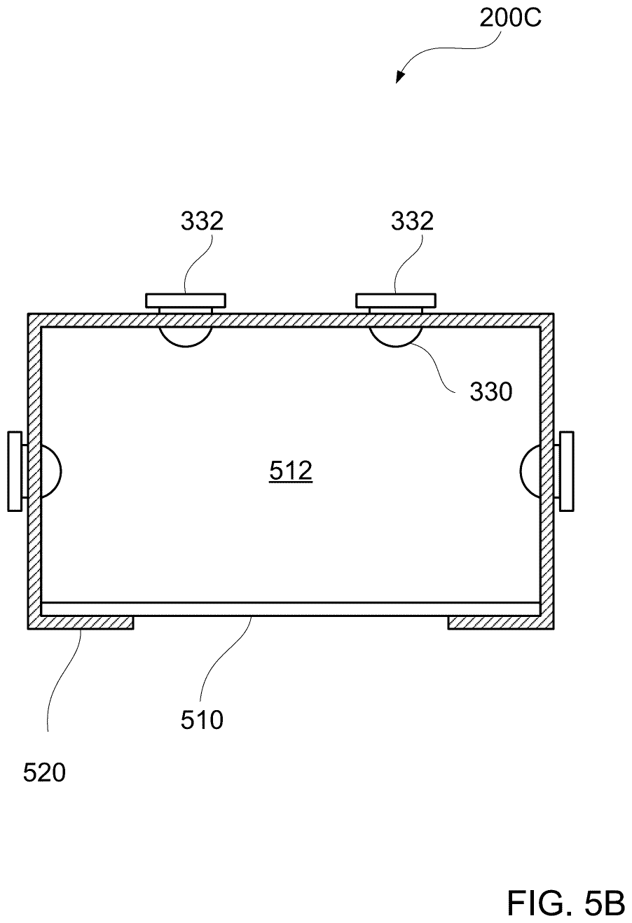

FIGS. 5A-5B illustrate a third configuration 200C of the conduit 200, according to embodiments of the present disclosure. The third configuration 200C includes a conduit 200, illustrated in FIGS. 5A-5B as a rectangular prism. This disclosure further contemplates embodiments of the third configuration 200C of the conduit 200 having cross-sections of other polygons (e.g. hexagons, octagons, and the like). The slurry channel 512 is formed on a first side of the conduit 200 by a transparent pane 510. The transparent pane 510 is oriented towards the reflective structures 125 when implemented in a photoreactor 110. The slurry channel is formed on the remaining three sides of the conduit 200 by a rectangular conduit 520. The third configuration 200C does not include a wiring channel, as the LED array is inlaid through the external surfaces of the rectangular conduit 520, and the dissipation plates 332 and wires are external to the rectangular conduit 520 and the slurry channel 512.

According to some embodiments, the pane 510 is transparent, or includes a transparent portion, such that external photons, (e.g., rays 132) may effectively enter the conduit 200. The pane 510 may also be constructed of a non-reactive transparent material, which may be selected respondent to a desired photochemical reaction to be conducted in the photoreactor 110. According to some embodiments, the pane 510 may be constructed of quartz, glass, acrylic, polyvinyl chloride, nylon, polyurethane, polyethylene, polycarbonate, plexiglass, combinations thereof, and the like.

According to some embodiments, the rectangular conduit 520 may be constructed of a material that is non-reactive with the slurry used for the desired photochemical reaction or include a coating or finish that serves as a barrier between the surface of the rectangular conduit 520 and the slurry. According to some embodiments, the rectangular conduit 520 may be constructed of a metal (e.g., aluminum, copper, steel, brass, nickel, silver, gold, titanium, palladium, various alloys, and the like), quartz, glass, acrylic, plastic, polyvinyl chloride, nylon, polyurethane, polyethylene, polycarbonate, plexiglass, and combinations thereof. Further, the rectangular conduit 520 may include a coating or finish, which may include, silicon-based coatings (silicon dioxide, silicon oxide), metal finishes (via electrolytic deposition or otherwise), ceramic coatings, plastic coatings, combinations thereof and the like.

According to some embodiments, the third configuration 200C may include LEDs 330 disposed through the surfaces of the rectangular conduit 520. As illustrated in FIG. 5B, the third configuration 200C includes LEDs 330 disposed on all three longitudinal surfaces of the rectangular conduit 420. In some examples, the LEDs 330 may be disposed on a single side, only two sides, or in embodiments with a greater number of sides, four or more sides. Placement of the LEDs 330 may be determined by the unit output of the LEDs 330, the configuration of the solar energy system 100 (e.g., such that light contacts a single side of the conduit 200 vs. multiple sides of the conduit 200, volume of external light input, etc.), or the light requirements of a desired photochemical reaction to be conducted in the photoreactor 110. The placement density of LEDs 330 along a single side may also be determined and implemented responsive to the same parameters.

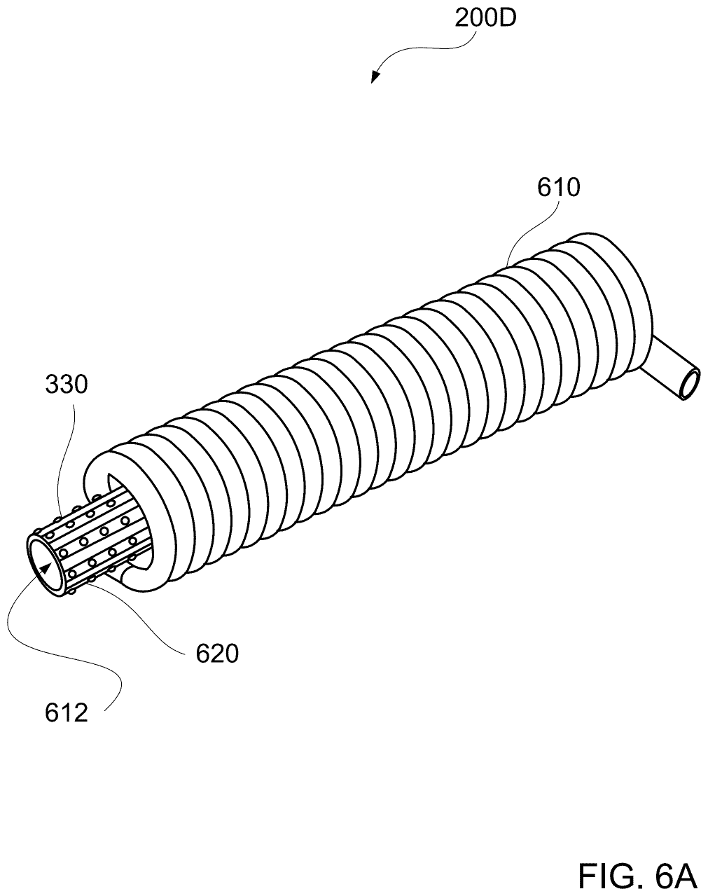

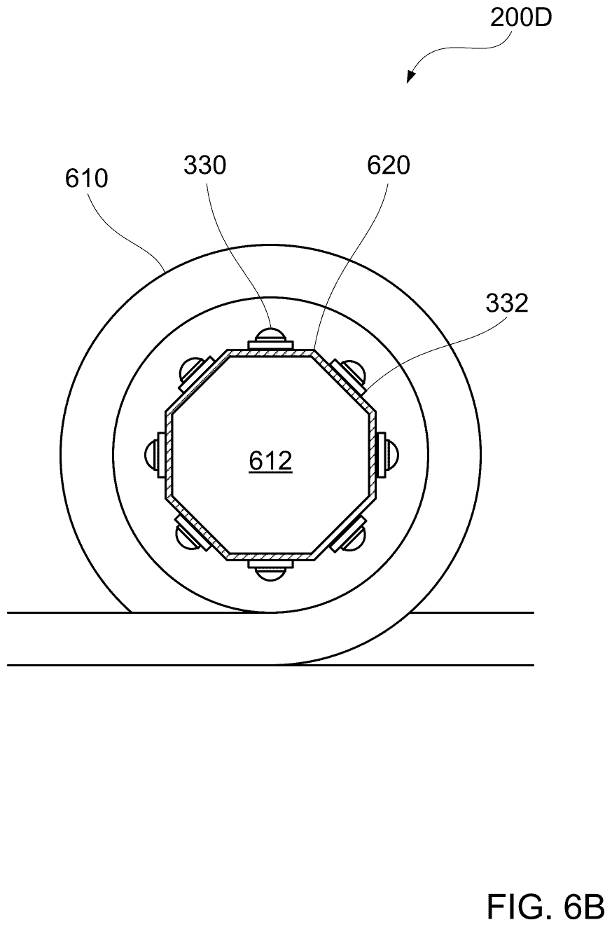

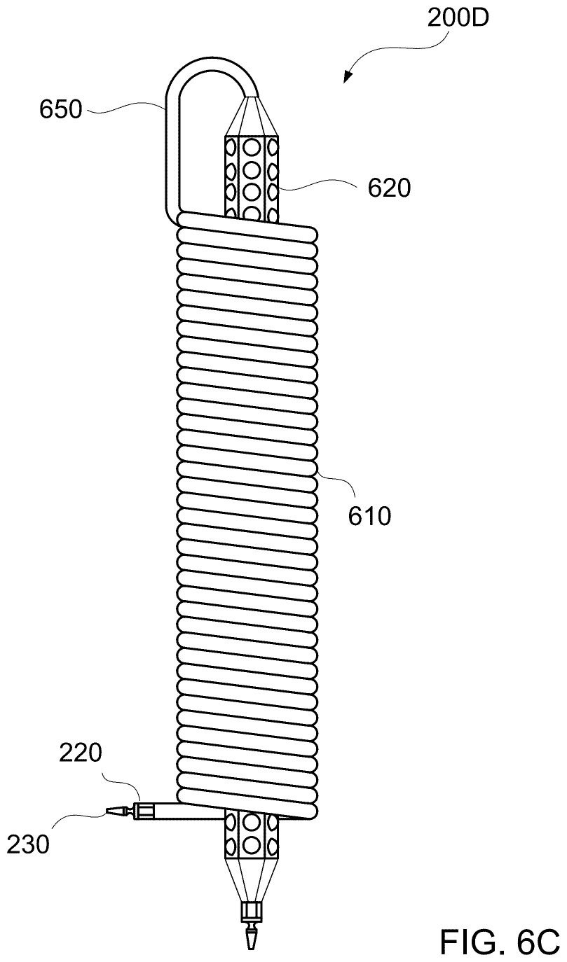

FIG. 6A-6C illustrate a fourth configuration 200D of the conduit 200, according to various examples of the present disclosure. In the fourth configuration 200D the conduit 200 includes a tube 610 which is disposed about a lighting conduit 620 in a helical manner. The photoreactive slurry is disposed within the tube 610 and is physically isolated from the lighting conduit. The lighting conduit includes 620 a plurality of surfaces on which LEDs 330 are disposed and defines a channel 612 within the lighting conduit. In some embodiments, the channel 612 serves to house the wires and dissipation plates 332 associated with the LEDs 330. In other embodiments, the wires and dissipation plates 332 associated with the LEDs 330 may be disposed on the outer surface of the lighting conduit 612 alongside the LEDs 330, and the channel 312 includes a fluid connection to the tube 610 (See FIG. 6C), where photoreactive slurry passes through the channel 612 before entering the tube 610.

According to some embodiments, the tube 610 is transparent, or includes a transparent portion, such that external photons, (e.g., from rays 132) may effectively enter the conduit 200. The tube 610 may also be constructed of a non-reactive transparent material, which may be selected respondent to a desired photochemical reaction to be conducted in the photoreactor 110. According to some embodiments, the tube 310 may be constructed of quartz, glass, acrylic, polyvinyl chloride, nylon, polyurethane, polyethylene, polycarbonate, plexiglass, combinations thereof, and the like.

As illustrated in FIGS. 6A-6B, the lighting conduit 620 has a circular or polygonal cross section, which facilitates multiple surfaces for the disposition of LEDs 330. According to some embodiments, the lighting conduit 620 may possess a circular cross section, or a polygonal cross section (e.g., square, rectangular, hexagonal, octagonal, and the like). The lighting conduit 620 may be constructed of a material that is non-reactive with the slurry used for the desired photochemical reaction or include a coating or finish that serves as a barrier between the surface of the channel 612 and the slurry. According to some embodiments, the lighting conduit 620 may be constructed of a metal (e.g., aluminum, copper, steel, brass, nickel, silver, gold, titanium, palladium, various alloys, and the like), quartz, glass, acrylic, plastic, polyvinyl chloride, nylon, polyurethane, polyethylene, polycarbonate, plexiglass, and combinations thereof. Further, the lighting conduit 620 may include a coating or finish, which may include, silicon-based coatings (silicon dioxide, silicon oxide), metal finishes (via electrolytic deposition or otherwise), ceramic coatings, plastic coatings, combinations thereof and the like.

FIG. 6C illustrates a fluid connector 650 disposed between an inlet of the tube 610 and an outlet of the channel 612 of the lighting conduit 620, according to various examples of the present disclosure. Photoreactive slurry may be passed through the channel 612 to “preheat” the slurry by convectively removing excess heat conducted into the lighting conduit 620 by the LEDs 330 disposed on the surface thereof. After preheating, the slurry may be passed through the fluid connector 650 and into the tube 610, where the slurry may be exposed to photons and begin the photochemical reaction process.

Referring generally to the conduit 200, and the various above-described configurations (e.g. first configuration 200A, second configuration 200B, and third configuration 200C), the LED 330 array disposed in contact with the photoactive slurry provides several functional benefits. The LED 330 array adds additional photons of similar electromagnetic spectrum to the Sun 130 or optimized spectrum to the photoreactive slurry to aid in driving of the photochemical reaction occurring in the photoreactor. The additional photons may be used to offset the impact of changes in the quantity of reflected light from the Fresnel system 120 over the course of a solar cycle, facilitating a consistent rate of reaction in the photoreactive slurry.

Additionally, many photochemical reactions are more efficient, or have greater rates of reactions at higher temperatures and the LED 330 array outputs waste heat as a by-product of light production, which may be transferred to the slurry. The photoreactive slurry may be employed to convectively remove excess heat from the LED 330 array which serves a duplicate purpose. Primarily, the removed heat may increase the reaction efficiency of the photochemical reaction, and secondly, the slurry removing the heat may facilitate the LED array to operate at an increased output level without exceeding limiting specifications for operating temperature. In some examples, the heat removal process may decrease, or maintain a temperature of the LED 330 array.

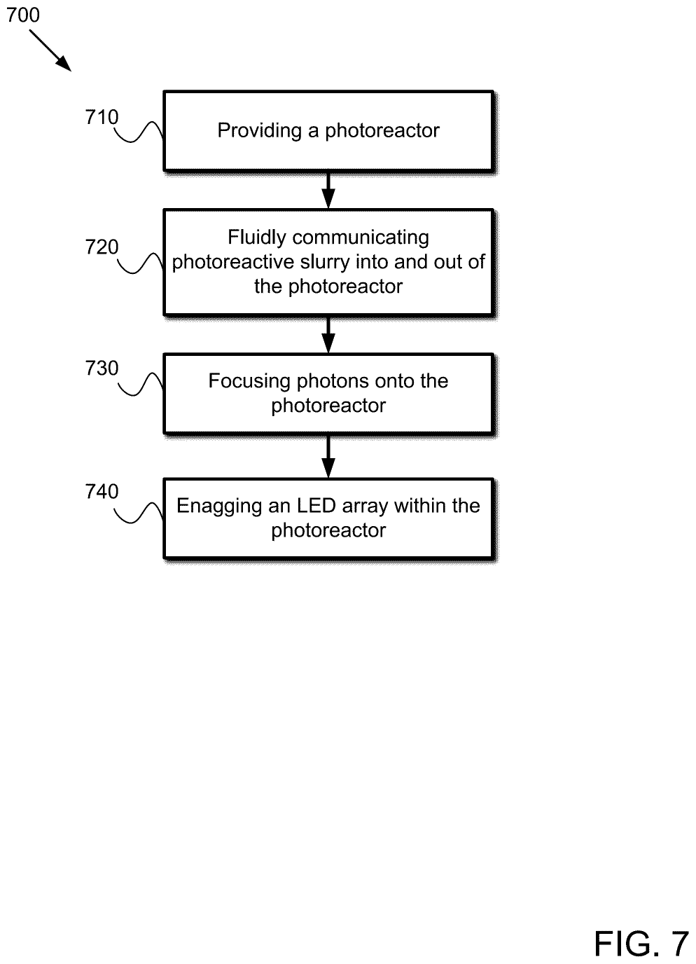

FIG. 7 is a flowchart for an example method 700 of facilitating a photochemical reaction, according to embodiments of the present disclosure. Block 710 describes providing a photoreactor (e.g., photoreactor 110). According to some embodiments, the photoreactor includes one or more transparent conduits, or conduits having a transparent portion (e.g., conduit 200), the conduits housing LED arrays and photoreactive slurry. The conduits are configured such that light (e.g., photons, rays) may enter the conduit through the transparent portions, and interface with the photoreactive slurry, thus facilitating a photochemical reaction.

Block 720 describes fluidly communicating photoreactive slurry in and out of the photoreactor, according to embodiments of the present disclosure. According to some embodiments, the conduits include inlets and outlets, configured to facilitate fluid communication of the photoreactive slurry in and out of the conduits and thus the photoreactor. The outlets facilitate the removal of expended photoreactive slurry, saturated, or partially saturated with reaction products. The inlets facilitate the input of new photoreactive slurry saturated with reactants to the conduits.

According to some embodiments, the inflow and outflow of photoreactive slurry may be driven by a pump, or pumps, in communication with a controller or control system. According to some embodiments, the inflow and outflow of photoreactive slurry may be driven or aided by gravitational forces, forces corresponding to reaction pressure, and convective action within the photoreactive slurry. The flowrate of photoreactive slurry through the photoreactor may correspond to several parameters, which may include path length through the conduit(s), input volume of photons, reaction speed of the photochemical reaction being facilitated, and the like. In some embodiments, the photoreactive slurry is supplied from an external source or reservoir, and in some embodiments the photoreactive slurry is output to an external reservoir, or to a processing system where the slurry may be recycled and the chemical products may be isolated and removed.

Block 730 describes focusing photons onto the photoreactor, according to embodiments of the present disclosure. According to some embodiments, focusing the photons on the photoreactor may be achieved using a Fresnel system (e.g., a linear Fresnel system 120) configured to reflect and concentrate rays from the sun onto the photoreactor. A Fresnel system may include several reflective structures (e.g., reflective structures 125), which are independently articulatable, and can reflect the sun's rays to a desired point or plane. When used in tandem, a plurality of reflective structures may redirect rays from the sun, which are naturally incident over a large surface area, to a comparably smaller area or focus, thus increasing the photon density at the focus. When the focus is manipulated such that the focus is incident with the photoreactor, specifically the transparent portions of the conduits, a much larger quantity of photons may be directed into the photoreactive slurry, compared to the quantity of photons in otherwise naturally incident rays.

Block 740 describes engaging an LED array within the photoreactor, according to embodiments of the present disclosure. According to some embodiments, an LED array may be disposed in each conduit of the photoreactor. Engaging the LED arrays increases the light input to the photoreactive slurry, thus increasing the number of photons driving the photochemical reaction occurring therein. According to some embodiments, the volume of photons input to the photoreactive slurry may be controlled to account for changes in the reflected light input from block 730. Over the course of a solar cycle, the intensity and volume of the rays that are incident with the Fresnel system may change due to light angles, weather patterns, and other factors, thus the output of the LED array may be adjusted such that the total light input to the photoreactive slurry, including the reflected photons and the LED generated photons is nearly constant, or within a predefined range. In some examples the predefined range corresponds to a photochemical product output criteria.

With regards to the total light input to the photoreactive slurry, a rate at which photons are introduced to the conduit via the combination an external source (e.g., the Sun 130) and the LEDs 330 may be of particular relevance to the photochemical reaction, as this metric may correspond to several operational parameters of the solar energy system. The rate may be expressed in terms of a gross input of photons to the conduit per unit time, an input of photons per unit area per unit time, an input of specific wavelength photons per unit area per unit time, or other similar metrics. As discussed above, it may be desirable to maintain a constant rate of reaction in the photoreactor. As used herein, the terms “constant” and “nearly constant” are taken to mean within tolerances of a predetermined setpoint, where in various embodiments, the tolerances may be about 20 percent, about 10 percent, about 5 percent, about 1 percent, or about 0.1 percent, from the setpoint. As a non-limiting example, in an example embodiment where the predetermined setpoint for the rate of photon introduction is 5×10²⁰ photons per second, a “constant” rate may encompass fluctuations between 4.5×10²⁰ and 5.5×10²⁰ photons per second. To maintain a constant rate of photochemical reaction, it may be advantageous to maintain the rate at which photons are introduced at a constant setpoint. As the light production from the Sun may vary over the course of a solar cycle, the LEDs may be used as a compensatory measure to ensure that the rate of photon introduction is constant, thus maintaining a constant rate of reaction. Stated differently, the LED array may be controlled such that a first sum of photons introduced to the conduit over a first period of time of a predefined duration from the external source and the LED array is substantially equal to a second sum of photons introduced to the conduit over a second period of time of the predefined duration from the external source and the LED array, where the quantity of photons received form the external source are variable.

According to some embodiments, the output of the LED array may be controlled by a control system or controller, in communication with sensors configured to detect light, product output, or other parameters that affect or are affected by the light reflected by the Fresnel system.

Although the method has been described in certain specific aspects, many additional modifications and variations would be apparent to those skilled in the art. In particular, any of the various processes described above can be performed in alternative sequences and/or in parallel in order to achieve similar results in a manner that is more appropriate to the requirements of a specific application. It is therefore to be understood that the present disclosure can be practiced otherwise than specifically described without departing from the scope and spirit of the present embodiments. Thus, embodiments of the present invention should be considered in all respects as illustrative and not restrictive. It will be evident to the annotator skilled in the art to freely combine several or all of the embodiments discussed here as deemed suitable for a specific application of the invention. Throughout this disclosure, terms like “advantageous”, “exemplary” or “preferred” indicate elements or dimensions which are particularly suitable (but not essential) to the invention or an embodiment thereof, and may be modified wherever deemed suitable by the skilled annotator, except where expressly required. Accordingly, the scope of the invention should be determined not by the embodiments illustrated, but by the appended claims and their equivalents.

The invention is claimed as follows:

1. A photoreactor, comprising:
a conduit, having a transparent portion; and
a light-emitting diode (LED) array disposed within the conduit;
wherein:
the conduit is configured such that photons from an external source enter the conduit through the transparent portion; and
the LED array is directed to emit photons into the conduit.

2. The photoreactor of claim 1, wherein the LED array is controlled such that a first sum of photons received over a first period of time of a predefined duration from the external source and the LED array is substantially equal to a second sum of photons received over a second period of time of the predefined duration from the external source and the LED array, wherein a different quantity of photons are received from the external source during the first period of time and the second period of time.

3. The photoreactor of claim 1, wherein the conduit is configured to carry a photoreactive slurry that produces a chemical product when the photoreactive slurry interfaces with at least one of the photons from the external source and photons emitted by the LED array.

4. The photoreactor of claim 1, wherein the conduit includes an inlet configured to facilitate an input of a photoreactive slurry containing chemical reactants to the conduit, and an outlet configured to facilitate removal of the photoreactive slurry containing chemical products from the conduit.

5. The photoreactor of claim 1, configured such that a photoreactive slurry promotes convective removal of excess heat produced by the LED array, decreasing, or maintaining a temperature of the LED array and recuperating required thermal input to the photoreactive slurry.

6. The photoreactor of claim 1, wherein the LED array includes a wiring conduit disposed within the conduit separate from a flow path for a photoreactive slurry through the conduit, such that light-emitting portions of LEDs are disposed on a surface of the wiring conduit contacting the photoreactive slurry, and wires and electrical contacts of the LEDs are physically isolated from the photoreactive slurry within the wiring conduit.

7. The photoreactor of claim 1, wherein the LED array is integrated into a surface of the conduit, such that light emitting portions of LEDs a disposed on an internal surface of a flow path for a photoreactive slurry through the conduit to contact the photoreactive slurry, and wires and electrical contacts of the LEDs are physically isolated from the photoreactive slurry on an external surface of the conduit.

8. The photoreactor of claim 1, wherein the photoreactor includes a group of multiple conduits, each conduit containing an LED array, wherein:
each conduit in the group of conduits is has an inlet configured to receive a photoreactive slurry from one of an external slurry source or an upstream conduit in the group of conduits, and
each conduit in the group of conduits has an outlet configured to output the photoreactive slurry to one of an external reservoir or a downstream conduit in the group of conduits.

9. The photoreactor of claim 8, wherein the conduits in the group of conduits are arranged in a parallel array, and the outlet of a given conduit is fluidly connected to the inlet of another conduit by a U-shaped connector.

10. The photoreactor of claim 1, wherein the photons from the external source are directed into the conduit by an articulatable reflective structure, configured to focus rays of the Sun.

11. A system, comprising,
an articulatable reflective structure, configured to focus rays of the Sun;
a photoreactor, including:
a conduit, having a transparent portion and configured to house a photoreactive slurry; and
a light-emitting diode (LED) array disposed within the conduit;
wherein:
the reflective structure is configured to focus the rays into the transparent portion of the conduit, such that photons from the rays interface with the photoreactive slurry;
the LED array is directed to emit photons into the conduit; and
the conduit is configured such that photons from an external source enter the conduit through the transparent portion.

12. The system of claim 11, wherein:
the photoreactor includes a group of multiple conduits, each conduit containing an LED array, wherein:
each conduit in the group of conduits is has an inlet configured to receive a photoreactive slurry from one of an external source and an upstream conduit in the group of conduits, and
each conduit in the group of conduits has an outlet configured to output the photoreactive slurry to one of an external reservoir and a downstream conduit in the group of conduits.

13. The system of claim 12, wherein the conduits in the group of conduits are arranged in a parallel array, and the outlet of a given conduit is fluidly connected to the inlet of another conduit by a U-shaped connector.

14. The system of claim 13, wherein the photoreactor includes multiple groups of multiple conduits, the groups arranged in an array.

15. The system of claim 11, including a plurality of articulatable reflective structures configured to focus light from the external source into the conduit.

16. The system of claim 12, further comprising a control system, the control system configured to:
manipulate a position of the articulatable reflective structure, thus changing a direction or point of focus of the rays;
change a photon output of at least one LED in the LED array;
change an input rate and an output rate of a photoreactive slurry to and from the photoreactor.

17. A method of facilitating photochemical reactions comprising:
providing a photoreactor including a plurality of conduits having a transparent portion, a light-emitting diode (LED) array disposed within each conduit;
communicating, fluidly, a photoreactive slurry, through a flow path defined in each conduit and in contact with the LED array;
focusing photons from a light source external to the photoreactor onto the photoreactor, such that the photons from the light source external to the photoreactor interface with the photoreactive slurry; and
engaging the LED array such that photons from the LED array interface with the photoreactive slurry; and
communicating, fluidly, the photoreactive slurry containing reaction products out of the conduit.

18. The method of claim 17, wherein engaging the LED array comprises controlling an output of the LED array, such that a first sum of photons received over a first period of time of a predefined duration from the external source and the LED array is substantially equal to a second sum of photons received over a second period of time of the predefined duration from the external source and the LED array, wherein a different quantity of photons are received from the external source during the first period of time and second period of time.

19. The method of claim 17, wherein focusing photons from a light source external to the photoreactor comprises articulating a plurality of reflective structures disposed proximately to the photoreactor to reflect and concentrate rays of light onto the transparent portion of the photoreactor.
